(19) United States
(12) Patent Application Publication
(10) Pub. No.: US 2025/0091354 A1
(43) Pub. Date: Mar. 20, 2025

(54) INK REPLENISHMENT CONTAINER

(71) Applicant: SEIKO EPSON CORPORATION, Tokyo (JP)

(72) Inventors: Tadahiro MIZUTANI, Shiojiri-shi (JP); Tadashi WATANABE, Matsumoto-shi (JP); Yuta KOIKE, Matsumoto-shi (JP)

(73) Assignee: SEIKO EPSON CORPORATION, Tokyo (JP)

(21) Appl. No.: 18/889,898

(22) Filed: Sep. 19, 2024

(30) Foreign Application Priority Data
Sep. 20, 2023 (JP) 2023-151923

(51) Int. Cl. B41J 2/175

(52) U.S. Cl. CPC B41J 2/17506; B41J 2/17596

(57) ABSTRACT

An ink replenishment container that replenishes ink into a printer includes: a container body; and an ink outlet forming portion including a tube portion, in which the ink outlet forming portion includes a spring valve including a valve body mounted in the tube portion and a spring biasing the valve body toward an ink outlet, and a sealing member mounted in the tube portion and having a valve sealing portion in contact with the valve body in a valve-closed state, the sealing member has an inner circumferential wall and an elastic portion extending from the inner circumferential wall toward a center of the sealing member, and the elastic portion has slits extending in a radial direction from the center toward the inner circumferential wall, a plurality of small pieces divided by the slits, and a bent portion positioned between the plurality of small pieces and the inner circumferential wall.

The present application is based on, and claims priority from JP Application Serial Number 2023-151923, filed Sep. 20, 2023, the disclosure of which is hereby incorporated by reference herein in its entirety.

### BACKGROUND

### 1. Technical Field

The present disclosure relates to an ink replenishment container.

### 2. Related Art

Hitherto, an ink jet printer that performs printing on a print medium such as printing paper with ink by ejecting the ink from a print head toward the print medium has been known as an example of an ink ejecting apparatus. Examples of such an ink jet printer include an ink replenishment type printer that is used by replenishing ink in an ink tank. JP-A-2023-51714 discloses an ink replenishment container used for replenishing ink in an ink replenishment type ink tank. The ink replenishment container includes a tube portion having an ink outlet, a valve body disposed in the tube portion, and a sealing member that is disposed in the tube portion and comes into contact with the valve body in a valve-closed state. The sealing member has a slit-like gap passing through the center thereof.

In the related art, when an ink inlet flow path member of a printer is inserted into the ink outlet of the ink replenishment container via the sealing member, the ink inlet flow path member may be inserted in a state in which the center of the ink flow path member is deviated in a radial direction from the center of the sealing member. In this case, in the ink replenishment container according to the related art, the sealing member may not be able to follow the ink inlet flow path member due to variations in the way in which the slit is opened, which may result in leakage of ink to the outside of the ink inlet flow path member. In addition, when there are variations in the way in which the gap is opened, excessive air may enter the ink replenishment container, which can cause over-injection of the ink into the ink tank.

### SUMMARY

The present disclosure can be implemented in the following aspects.

According to an aspect of the present disclosure, an ink replenishment container is provided. The ink replenishment container that replenishes ink in an ink tank of a printer via an ink inlet flow path member that communicates with the ink tank includes: a container body configured to contain the ink; and an ink outlet forming portion connected to the container body and including a tube portion having an ink outlet, in which the ink outlet forming portion includes: a spring valve that includes a valve body mounted in the tube portion, and a spring biasing the valve body toward the ink outlet in a first direction along a central axis of the ink outlet in a valve-closed state, the spring valve configured to take a valve-opened state where the valve body is pushed by the ink inlet flow path member inserted into the tube portion in a second direction opposite to the first direction; and a sealing member that is mounted in the tube portion and has a valve sealing portion that is in contact with the valve body in the valve-closed state, the sealing member has a cylindrical inner circumferential wall centered on the central axis and an elastic portion extending from the inner circumferential wall toward a center of the sealing member, the elastic portion has slits that include the center and extend in a radial direction from the center toward the inner circumferential wall, a plurality of small pieces divided by the slits, and a bent portion positioned between the plurality of small pieces and the inner circumferential wall, and the spring valve is configured to take the valve-opened state where the elastic portion is pushed by the ink inlet flow path member to open the slits and the valve body is pushed by the ink inlet flow path member.

### BRIEF DESCRIPTION OF THE DRAWINGS

FIG. 1 is a perspective view of a printer in a first embodiment.

FIG. 2 is a perspective view illustrating a state in which an ink replenishment container is used to replenish ink in an ink tank.

FIG. 3 is an exploded perspective view of the ink replenishment container in the first embodiment.

FIG. 4 is a perspective view of an outlet valve unit.

FIG. 5 is a perspective view illustrating a state in which an ink inlet flow path member is inserted into the outlet valve unit.

FIG. 6 is a perspective view of a sealing member.

FIG. 7 is a cross-sectional view of the sealing member.

FIG. 8 is a front view of the ink replenishment container in an upright state.

FIG. 9 is a plan view of the ink replenishment container in the upright state.

FIG. 10 is a perspective view of the ink tank of the first embodiment.

FIG. 11 is a cross-sectional view illustrating a replenishment state.

FIG. 12 is a cross-sectional view illustrating a state in which the ink replenishment container is removed from the ink inlet flow path member.

FIG. 13 is a cross-sectional view illustrating a valve-closed state in which the ink inlet flow path member and the sealing member are not in contact with each other.

FIG. 14 is a cross-sectional view illustrating a state in which the ink inlet flow path member and a bent portion are in contact with each other.

FIG. 15 is a cross-sectional view illustrating deformation of the bent portion.

FIG. 16 is a cross-sectional view illustrating deformation of the bent portion in a valve-opened state.

FIG. 17 is a cross-sectional view of a sealing member in a second embodiment.

FIG. 18 is a perspective view illustrating a sealing member in Another Embodiment 1.

### DESCRIPTION OF EMBODIMENTS

### A. First Embodiment

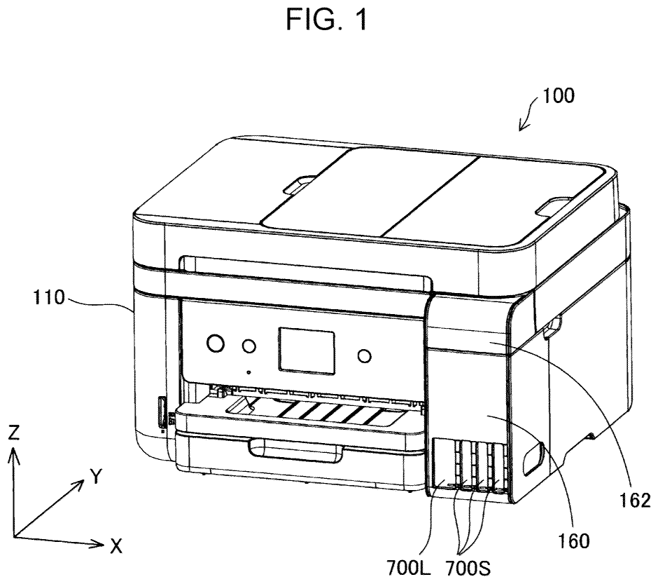

FIG. 1 is a perspective view of a printer in a first embodiment. A printer 100 is an ink jet printer that performs printing by ejecting ink onto a print medium. An X axis, a Y axis, and a Z axis orthogonal to each other are depicted in FIG. 1. The X axis corresponds to a width direction of the printer 100, the Y axis corresponds to a depth direction of the printer 100, and the Z axis corresponds to a height direction of the printer 100. The printer 100 is installed on a horizontal installation surface defined by an X-axis direction and a Y-axis direction. Note that the “X-axis direction” refers to a combination of a +X direction and a −X direction. Similarly, the “Y-axis direction” refers to a combination of a +Y direction and a −Y direction, and a “Z-axis direction” refers to a combination of a +Z direction and a −Z direction.

The printer 100 includes a housing 110. A carriage (not illustrated) that is movable in a main scanning direction that is the X-axis direction is provided inside the housing 110. A print head that ejects the ink onto the print medium is installed on the carriage. An ink tank housing unit 160 that houses a plurality of ink tanks 700S and 700L is provided at one end of a front surface of the housing 110. The ink tank housing unit 160 includes an openable and closable lid 162 provided at an upper portion of the ink tank housing unit 160. The ink tank 700S is a small capacity tank, and the ink tank 700L is a large capacity tank. However, in the following description, the ink tank 700S and the ink tank 700L will be simply referred to as an “ink tank 700” without distinguishing between them. Each ink tank 700 is connected to the print head of the carriage by a tube (not illustrated). That is, the ink tank 700 is a stationary ink tank that is not mounted on the carriage of the printer 100. Furthermore, each ink tank 700 is an ink replenishment type ink tank that is replenished with the ink from an ink replenishment container when an ink level decreases. Although the ink tank 700 is a stationary ink tank in the present embodiment, the ink tank 700 may also be an ink tank mounted on the carriage of the printer 100.

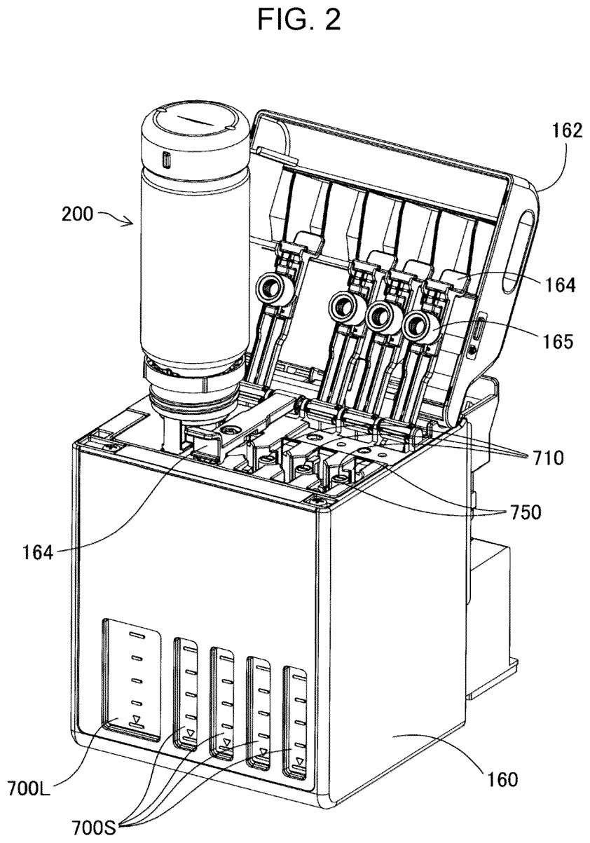

FIG. 2 is a perspective view illustrating a state in which an ink replenishment container 200 is used to replenish the ink in the ink tank 700. A front surface of each ink tank 700 is made of a transparent material, and the ink level in each ink tank 700 can be visually checked from the outside. When the ink level is low, it is possible to open the lid 162 and replenish the ink through an ink inlet flow path member 710 of the ink tank 700.

The tubular ink inlet flow path member 710 that communicates with the ink tank 700 is provided on an upper surface of each ink tank 700. The ink tank housing unit 160 includes a sealing cap member 164 including a sealing cap 165 for sealing a distal end of the ink inlet flow path member 710. When the ink tank 700 is not replenished with the ink, the distal end of the ink inlet flow path member 710 is sealed with the sealing cap 165 of the sealing cap member 164. When replenishing the ink in the ink tank 700, the sealing cap member 164 is removed from the ink inlet flow path member 710, and a front end of the ink replenishment container 200 is inserted at a position at which the ink inlet flow path member 710 is provided to replenish the ink. Two recesses 750 into which fitting portions of the ink replenishment container 200 described below are fitted are provided around the ink inlet flow path member 710. The recesses 750 have a shape that is rotationally symmetric 180 degrees around the ink inlet flow path member 710.

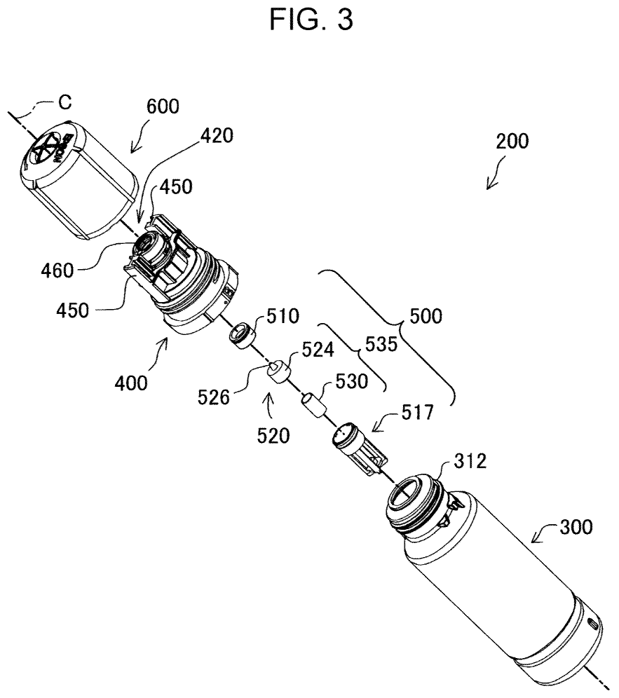

FIG. 3 is an exploded perspective view of the ink replenishment container 200 in the first embodiment. The ink replenishment container 200 includes a container body 300 configured to be able to contain the ink, an ink outlet forming portion 400 in which an ink outlet 460 is formed, and a cap 600 mounted on the ink outlet forming portion 400. The ink outlet forming portion 400 includes an outlet valve unit 500 provided inside the ink outlet forming portion 400. An upper end side of the ink replenishment container 200, which is a cap 600 side, is called a “front end side”, and a lower end side of the ink replenishment container 200, which is a container body 300 side, is called a “rear end side”. The container body 300 is a hollow cylindrical container having an opening on a front end side. An external screw 312 for mounting the ink outlet forming portion 400 is provided at a small diameter portion at a front end of the container body 300. In the present disclosure, a direction parallel to a central axis C of the ink replenishment container 200 is called an “axial direction”, and a direction perpendicular to the central axis C is called a “radial direction”.

The ink outlet 460 is provided at a front end of the ink outlet forming portion 400. The ink outlet forming portion 400 is connected to the container body 300 and includes a tube portion 420 having the ink outlet 460. The outlet valve unit 500 is mounted inside the tube portion 420. A valve housing 517 is mounted inside the tube portion 420 so as to form a gap in the radial direction between the tube portion 420 and the valve housing 517. When replenishing the ink in the ink tank 700, the ink inlet flow path member 710 of the ink tank 700 illustrated in FIG. 2 is inserted into the ink outlet 460.

Two fitting portions 450 are provided around the ink outlet 460. In the present embodiment, the two fitting portions 450 have a shape that is rotationally symmetric 180 degrees around the central axis C of the ink replenishment container 200. Furthermore, the fitting portions 450 are fitted into the recesses 750 provided around the ink inlet flow path member 710 of the ink tank 700 illustrated in FIG. 2. Therefore, it is possible to maintain the ink replenishment container 200 in a stable posture when replenishing the ink. Further, the fitting portions 450 can be configured such that, for example, the fitting portions 450 of the ink replenishment container 200 for replenishing yellow ink are fitted into the recesses 750 corresponding to the ink tank 700 containing yellow ink, and the fitting portions 450 of the ink replenishment container 200 for replenishing other colors of ink such as magenta ink or cyan ink cannot be fitted into the recesses 750 corresponding to the ink tank 700 containing yellow ink. As a result, it is possible to prevent erroneous ink injection. However, the fitting portions 450 can be omitted.

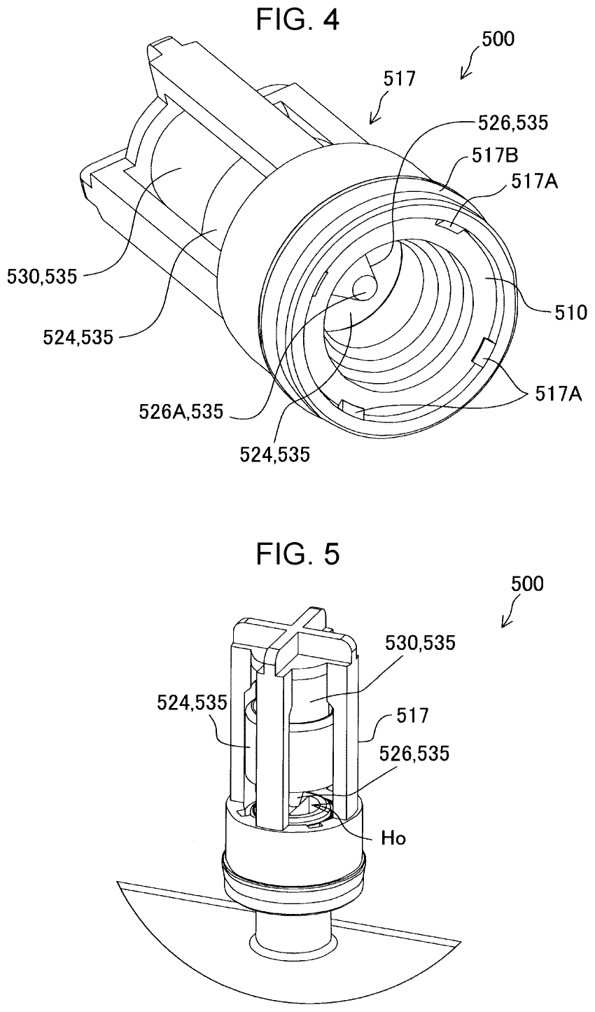

As illustrated in FIG. 3, the outlet valve unit 500 includes the valve housing 517, a sealing member 510, and a spring valve 535. FIG. 4 is a perspective view of the outlet valve unit 500. FIG. 5 is a perspective view illustrating a state in which the ink inlet flow path member 710 is inserted into the outlet valve unit 500.

The ink inlet flow path member 710 illustrated in FIG. 2 can be inserted into and removed from the valve housing 517. As illustrated in FIG. 4, the valve housing 517 includes a retaining portion 517A for the sealing member 510 and an engagement portion 517B for the tube portion 420 at a front end side. Further, as illustrated in FIG. 5, the valve housing 517 has a through-hole Ho penetrating in a direction intersecting the axial direction. The through-hole Ho is a hole penetrating through a side wall of the valve housing 517 in the radial direction centered on the central axis C, and is formed to extend in the axial direction as well. The through-hole Ho communicates with the gap in the radial direction between the valve housing 517 and the tube portion 420.

The spring valve 535 includes a valve body 520 and a spring member 530. As illustrated in FIGS. 3 to 5, the spring member 530 is housed in the valve housing 517. The spring member 530 is housed in the valve housing 517 at a rear end side in the axial direction. The spring member 530 can be made of, for example, metal. In the present embodiment, the spring member 530 is a coil spring. The spring member 530 biases the valve body 520 toward the ink outlet 460 in the first direction D1 along the central axis C of the ink outlet 460.

The valve body 520 is mounted in the valve housing 517 in such a way as to be movable in the axial direction. As illustrated in FIGS. 4 and 5, the valve body 520 includes a cylindrical portion 524 and a protruding portion 526. The valve body 520 has a configuration in which the protruding portion 526 is disposed on an end surface of the cylindrical portion 524 which is a substantially cylindrical member. The cylindrical portion 524 faces an inner surface of the valve housing 517. The valve body 520 can be formed using a thermoplastic resin such as polyethylene or polypropylene. As illustrated in FIG. 4, the protruding portion 526 of the valve body 520 has a tip portion 526A having a circular end surface that can come into contact with a partition wall 714 of the ink inlet flow path member 710 described below. Note that the tip portion 526A is not limited to having a circular end surface, and may have an end surface of any other shape, such as an elliptical end surface.

The spring valve 535 can be in a “valve-closed state” and a “valve-opened state”. Specifically, the valve body 520 is biased toward the sealing member 510 by the spring member 530. When the cylindrical portion 524 comes into contact with the sealing member 510, specifically, a valve sealing portion Eg, which is an annular protruding portion at a rear end of the sealing member 510, by such bias, the spring valve 535 transitions to the “valve-closed state”. In the “valve-closed state”, the cylindrical portion 524 is in contact with the sealing member 510, thereby closing an opening penetrating through the sealing member 510 in the axial direction. On the other hand, when the ink inlet flow path member 710 inserted into the tube portion 420 pushes the valve body 520 in the second direction D2 opposite to the first direction D1 that is a biasing direction of the spring member 530, and the cylindrical portion 524 is thus separated from the sealing member 510, the spring valve 535 transitions to the “valve-opened state”. In the “valve-opened state”, the cylindrical portion 524 is separated from the sealing member 510, thereby opening the opening penetrating through the sealing member 510 in the axial direction. That is, at the time of replenishing the ink, the spring valve 535 transitions to the “valve-opened state” when the ink inlet flow path member 710 is inserted into the cylindrical portion 420, and the spring valve 535 transitions to the “valve-closed state” when the ink inlet flow path member 710 is removed from the cylindrical portion 420.

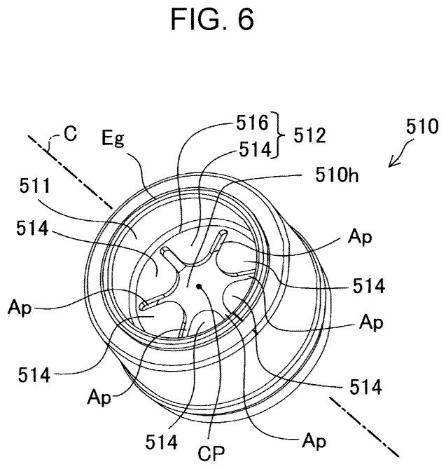

FIG. 6 is a perspective view of the sealing member 510. The sealing member 510 has a substantial ring shape. The sealing member 510 can be made of a rubber member such as an elastomer having rubber elasticity. The sealing member 510 has the opening through which the ink inlet flow path member 710 can be inserted and removed. The sealing member 510 is mounted in the cylindrical portion 420. As illustrated in FIG. 3, the sealing member 510 is positioned on a front end side of the spring member 530 in the axial direction.

As illustrated in FIG. 6, the sealing member 510 has the valve sealing portion Eg, which is the annular protruding portion that comes into contact with the valve body 520 in the “valve-closed state”. The sealing member 510 has a cylindrical inner circumferential wall 511 with the central axis C, and an elastic portion 512 extending from the inner circumferential wall 511 toward a center CP. The elastic portion 512 has slits Ap that include the center CP and extend in the radial direction from the center CP toward the inner circumferential wall 511, and a plurality of small pieces 514 divided by the slits Ap. The plurality of small pieces 514 have a sealing member through-hole 510h at the position of the center CP. The elastic portion 512 also has a bent portion 516 positioned between the plurality of small pieces 514 and the inner circumferential wall 511. In the present disclosure, the plurality of small pieces 514 are simply referred to as the “small pieces 514”.

The spring valve 535 transitions to the “valve-opened state” when the ink inlet flow path member 710 pushes the elastic portion 512 to open the slits Ap and pushes the valve body 520.

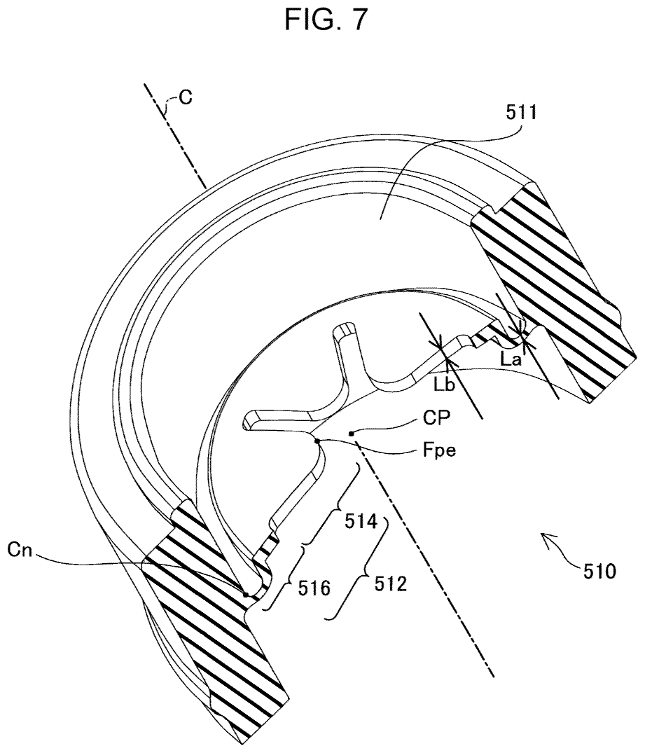

FIG. 7 is a cross-sectional view of the sealing member 510. In the present embodiment, the bent portion 516 of the elastic portion 512 is bent in such a way as to protrude toward the ink outlet 460 in the direction along the central axis C. In the present embodiment, “protruding toward the ink outlet 460” is not limited to a configuration in which a portion of the bent portion 516 closest to the ink outlet 460 in a cross section including the central axis C is positioned closer to the ink outlet 460 than a connection portion Cn between the bent portion 516 and the inner circumferential wall 511. The “protruding toward the ink outlet 460” also includes a configuration in which the bent portion 516 has a portion orthogonal to the inner circumferential wall 511. Further, a thickness La of the thinnest portion of the bent portion 516 in the direction along the central axis C is smaller than a thickness Lb of the thinnest portion of the small piece 514. Therefore, the bent portion 516 has a lower hardness than that of the small piece 514. The hardness can be evaluated using, for example, Young's modulus.

In the present embodiment, a point of the small piece 514 closest to the center CP is called a center side tip Fpe as illustrated in FIG. 7.

The components of the ink replenishment container 200 other than the outlet valve unit 500 can be formed using a thermoplastic resin such as polyethylene or polypropylene.

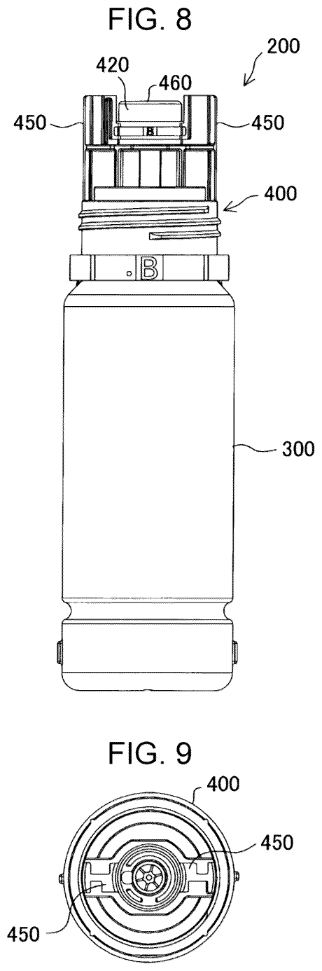

FIG. 8 is a front view of the ink replenishment container 200 in an upright state, and FIG. 9 is a plan view of the ink replenishment container 200 in the upright state. The “upright state of the ink replenishment container 200” means a state in which the container body 300 is placed on a horizontal surface such as a desk with a bottom portion of the container body 300 facing downward. As illustrated in FIG. 2, ink replenishment in the ink tank 700 is performed by inverting the ink replenishment container 200 such that the front end side of the ink replenishment container 200 faces downward. FIGS. 8 and 9 illustrate a state in which the cap 600 is removed.

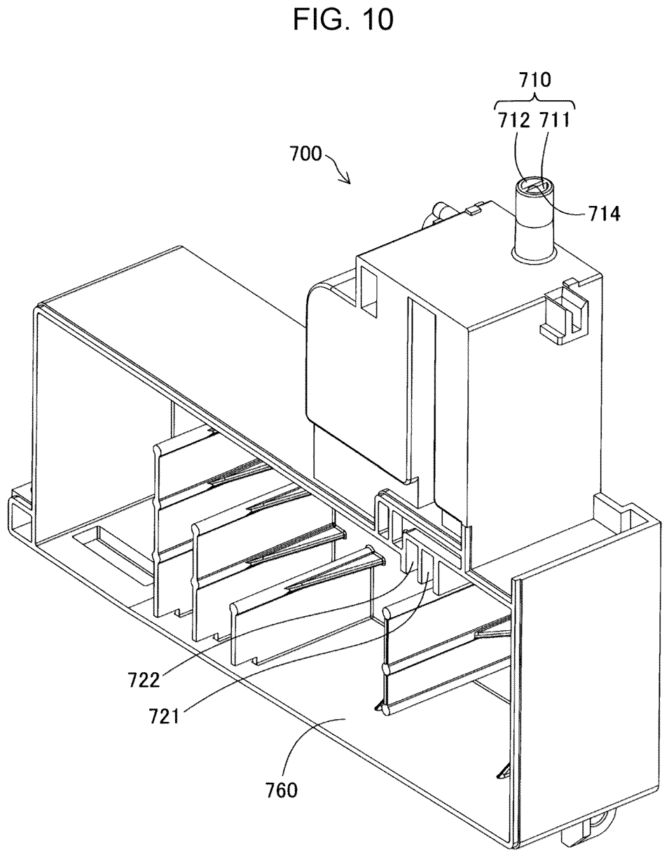

FIG. 10 is a perspective view of the ink tank 700 of the first embodiment. The ink inlet flow path member 710 of the ink tank 700 protrudes upward from the ink tank 700. The ink inlet flow path member 710 includes two flow paths 711 and 712. The two flow paths 711 and 712 are partitioned by the partition wall 714. In the first embodiment, a distal end surface of the ink inlet flow path member 710 is flat, and the two flow paths 711 and 712 are each opened at the distal end surface of the ink inlet flow path member 710. A part of the distal end surface of the ink inlet flow path member 710 corresponds to an end portion of the partition wall 714. At the time of replenishing the ink, the fitting portions 450 of the ink replenishment container 200 are fitted into the recesses 750 around the ink inlet flow path member 710 of the ink tank 700. As a result, the two flow paths 711 and 712 communicate with two in-tank flow paths 721 and 722 that protrude toward an ink containing chamber 760 below, respectively. Lower ends of the in-tank flow paths 721 and 722 extend to positions lower than a ceiling wall of the ink containing chamber 760.

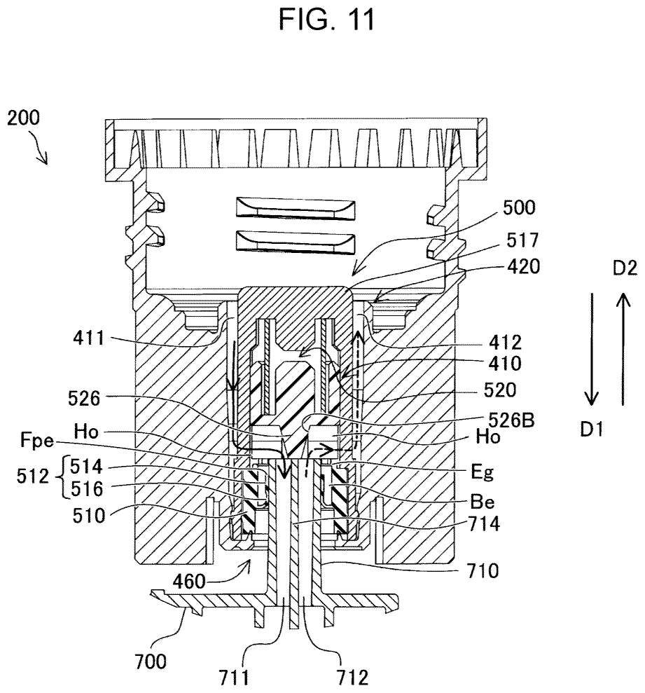

FIG. 11 is a cross-sectional view illustrating a state in which the ink is replenished from the ink replenishment container 200 to the ink tank 700. FIG. 11 illustrates the ink replenishment container 200 and the ink tank 700 in a cross section including the central axis C and the center side tip Fpe of the small piece 514. In such a replenishment state, the ink replenishment container 200 is inverted, and a direction from a rear end of the ink replenishment container 200 to the front end of the ink replenishment container 200 is indicated as a front end side direction D1 or a first direction D1, which is a direction in which the ink replenishment container 200 is connected to the ink inlet flow path member 710. A direction from the front end of the ink replenishment container 200 to the rear end of the replenishment container 200 is indicated as a rear end side direction D2 or a second direction D2, which is a direction in which the ink replenishment container 200 is removed from the ink inlet flow path member 710. FIG. 11 illustrates only a part of each of the ink replenishment container 200 and the ink tank 700.

In the replenishment state illustrated in FIG. 11, the tube portion 420 is formed such that a gap Be into which the elastic portion 512 enters is provided between an inner surface of the tube portion 420 and an outer surface of the ink inlet flow path member 710. When the elastic portion 512 is pushed open by the insertion of the ink inlet flow path member 710, the elastic portion 512 enters the gap Be.

The ink inlet flow path member 710 of the ink tank 700 is inserted into a pipe-like flow path portion 410 through the opening of the sealing member 510. The pipe-like flow path portion 410 is formed as a flow path space inside the tube portion 420. The pipe-like flow path portion 410 includes a replenishment flow path that is a flow path on an inner circumferential surface side of the tube portion 420. The replenishment flow path is divided into two replenishment flow paths 411 and 412 formed by the gap between the valve housing 517 and the inner circumferential surface of the tube portion 420 when the protruding portion 526 of the valve body 520 comes into contact with the partition wall 714 of the ink inlet flow path member 710. The gap forming the replenishment flow paths 411 and 412 can also include a gap between the valve body 520 and the spring member 530 housed in the valve housing 517 and the inner circumferential surface of the tube portion 420 via the through-hole Ho. Therefore, the gap can also be said to be a gap between the outlet valve unit 500 and the inner circumferential surface of the tube portion 420 via the through-hole Ho. As described below, in the ink replenishment state, one of the two replenishment flow paths 411 and 412 is used as an ink flow path, and the other is used as an air flow path. As a result, the ink replenishment container 200 can replenish the ink while performing gas-liquid exchange with the ink tank 700. The flow path of the pipe-like flow path portion 410 does not need to be divided into two replenishment flow paths 411 and 412 via the flow paths 711 and 712 of the ink inlet flow path member 710 and the through-hole Ho of the valve housing 517, and may be formed as one replenishment flow path. Further, the protruding portion 526 of the valve body 520 may come into contact with the partition wall 714 that partitions the ink inlet flow path member 710 into three or more flow paths, so that the pipe-like flow path portion 410 is divided into three or more replenishment flow paths.

The outlet valve unit 500 is configured such that, in the replenishment state, the two replenishment flow paths 411 and 412 communicate with the two flow paths 711 and 712 of the ink inlet flow path member 710. In order for gas and liquid to flow in and out by communicating between the replenishment flow paths 411 and 412 and the two flow paths 711 and 712 of the ink inlet flow path member 710, it is necessary to transition to the “valve-opened state” that allows the gas and liquid to flow in and out via the through-hole Ho.

The protruding portion 526 of the valve body 520 is provided at a position facing the partition wall 714 of the ink inlet flow path member 710. In the replenishment state, the protruding portion 526 of the valve body 520 is pushed by the ink inlet flow path member 710 and retracted toward the container body 300 illustrated in FIG. 3, and the two flow paths 711 and 712 of the ink inlet flow path member 710 communicate with the two replenishment flow paths 411 and 412, respectively, via the through-hole Ho. In this way, the ink replenishment container 200 transitions to the valve-opened state. As a result, the ink in the container body 300 is allowed to flow into the ink inlet flow path member 710 via the replenishment flow paths 411 and 412. In FIG. 11, a solid arrow indicates the flow of ink, and a dashed arrow indicates the flow of air. As described above, in the replenishment state, the ink can be efficiently replenished from the ink replenishment container 200 to the ink tank 700 while performing gas-liquid exchange by using the two replenishment flow paths 711 and 712 of the ink inlet flow path member 710 and the two replenishment flow paths 411 and 412 of the pipe-like flow path portion 410. In order to smoothly perform the gas-liquid exchange, the replenishment flow path of the pipe-like flow path portion 410 may be divided into a plurality of replenishment flow paths. The same applies to an ink inlet flow path of the ink inlet flow path member 710. In this case, in the replenishment state, one or more of the plurality of replenishment flow paths may communicate with one or more of a plurality of ink inlet flow paths, and one or more other of the plurality of replenishment flow paths may communicate with one or more other of the plurality of ink inlet flow paths.

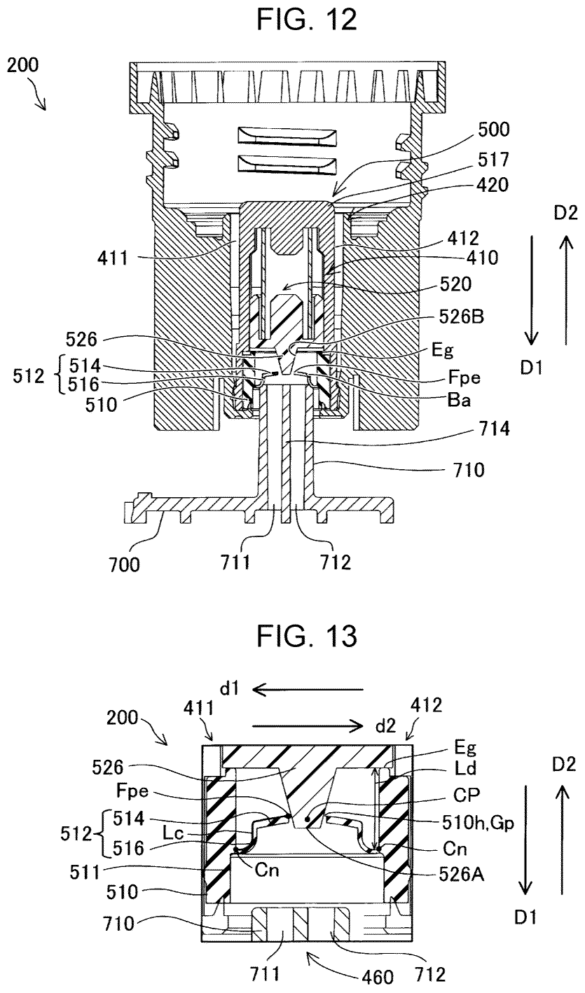

FIG. 12 is a cross-sectional view illustrating a state in which the ink replenishment container 200 is removed from the ink inlet flow path member 710. In FIG. 12, the ink inlet flow path member 710 is separated from the valve body 520, and the cylindrical portion 524 comes into contact with the valve sealing portion Eg of the sealing member 510, thereby closing the opening including the through-hole Ho in the axial direction. Therefore, the two flow paths 711 and 712 of the ink inlet flow path member 710 do not communicate with the two replenishment flow paths 411 and 412 of the pipe-like flow path portion 410. As a result, the ink replenishment container 200 transitions to the valve-closed state. In the present embodiment, the small piece 514 is formed such that the center side tip Fpe is positioned on a rear end side direction D2 side of a base Ba in the axial direction, and a cross-sectional shape of the small piece 514 is an arc shape.

As illustrated in FIGS. 2 and 3, in the present embodiment, the ink replenishment container 200 includes the fitting portions 450, and the fitting portions 450 are fitted into the recesses 750 of the ink tank 700. However, before the fitting portions 450 are fitted into the recesses 750 or when the ink replenishment container 200 does not include the fitting portions 450, the ink inlet flow path member 710 may be inserted while being deviated from the sealing member 510 in the radial direction.

In the ink replenishment container in which the sealing member 510 does not include the bent portion 516 according to the related art, when the ink inlet flow path member 710 is inserted in a state in which the center of the ink inlet flow path member 710 is deviated from the center CP of the sealing member in the radial direction, there may be variations in the way in which the slits Ap of the elastic portion are opened. In this case, the elastic portion cannot follow the ink inlet flow path member 710, and the ink may leak to the outside of the ink inlet flow path member 710. Furthermore, when the ink inlet flow path member 710 is inserted while being deviated from the sealing member in the radial direction, the gap between the elastic portion and the ink inlet flow path member 710 may be widened, and air may flow into the ink replenishment container through the gap. In this case, an excessive amount of ink may flow out of the ink replenishment container, or the ink tank 700 may be filled with the ink exceeding an upper limit.

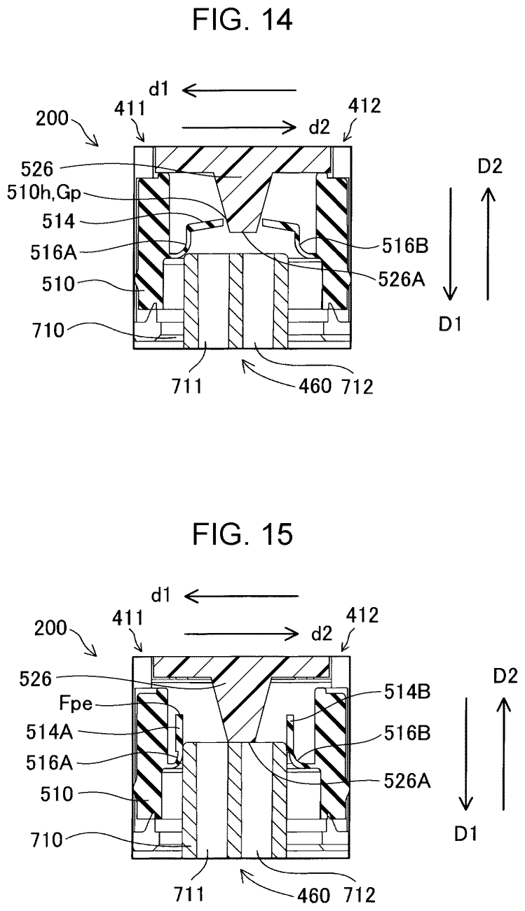

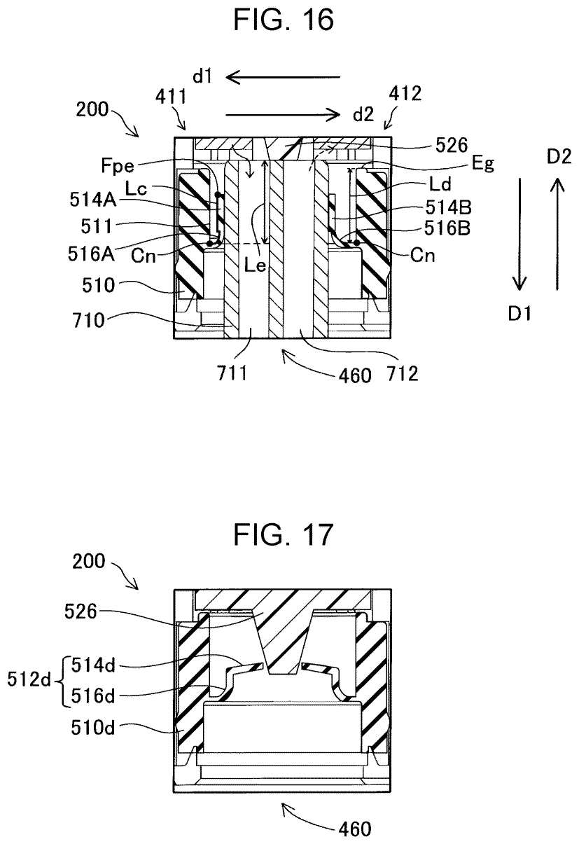

FIGS. 13 to 16 are cross-sectional views for describing a flow from the valve-closed state to the valve-opened state when the ink inlet flow path member 710 is inserted into the ink outlet 460 while being deviated in the radial direction in the first embodiment. FIG. 13 is a cross-sectional view illustrating the valve-closed state in which the ink inlet flow path member 710 and the sealing member 510 are not in contact with each other. FIG. 14 is a cross-sectional view illustrating a state in which the ink inlet flow path member 710 and the bent portion 516 are in contact with each other. FIG. 15 is a cross-sectional view illustrating deformation of the bent portion 516 in a state in which the ink inlet flow path member 710 and the protruding portion 526 are in contact with each other. FIG. 16 is a cross-sectional view illustrating deformation of the bent portion 516 in the valve-opened state. FIGS. 13 to 16 illustrate only a part of each of the ink replenishment container 200 and the ink tank 700.

In FIG. 13, the ink inlet flow path member 710 is inserted in a state in which the center of the ink inlet flow path member 710 is deviated from the center CP of the sealing member 510 in the radial direction. In the present disclosure, in the radial direction, a direction toward the replenishment flow path 411 when viewed from the central axis C is indicated as a d1 direction, and a direction toward the replenishment flow path 412 when viewed from the central axis C is indicated as a d2 direction. Here, on a straight line that passes through the center of the ink inlet flow path member 710 and is orthogonal to the partition wall 714, the d1 direction is a direction toward the flow path 711 when viewed from the center of the ink inlet flow path member 710, and the d2 direction is a direction toward the flow path 712 when viewed from the center of the ink inlet flow path member 710. In FIG. 13, the ink inlet flow path member 710 is inserted in a state in which the center of the ink inlet flow path member 710 is deviated from the center CP of the sealing member 510 in the d1 direction. In the present embodiment, the ink inlet flow path member 710 is inserted in a state in which the center of the ink inlet flow path member 710 is deviated from the center CP of the sealing member 510 in the d1 direction. However, the center of the ink inlet flow path member 710 may be deviated from the center CP of the sealing member 510 in the d2 direction or an arbitrary direction orthogonal to the central axis C.

As illustrated in FIG. 13, in the present embodiment, the small pieces 514 form the sealing member through-hole 510h at the position of the center CP, and the tip portion 526A of the valve body 520 is inserted into the sealing member through-hole 510h when the spring valve 535 is in the valve-closed state, and is separated from the plurality of small pieces 514. In other words, the tip portion 526A of the valve body 520 is positioned more toward the front end side direction D1 than the center side tip Fpe of the small piece 514. Furthermore, there is a gap Gp between the small piece 514 and the valve body 520 through which the ink can pass.

In FIG. 13, a length along an outer surface of the elastic portion 512 is Lc. The length Lc along the outer surface of the elastic portion 512 is a length from the connection portion Cn to the center side tip Fpe of the small piece 514. The length Lc is a length of a thick line in FIG. 13. A length in the direction along the central axis C from the connection portion Cn between the bent portion 516 and the inner circumferential wall 511 to the valve sealing portion Eg is Ld.

When the ink inlet flow path member 710 moves in the rear end side direction D2 in a state illustrated in FIG. 13, the ink inlet flow path member 710 comes into contact with the bent portion 516 as illustrated in FIG. 14. Since the ink inlet flow path member 710 is inserted while being deviated in the d1 direction from the center CP of the sealing member 510, the ink inlet flow path member 710 first comes into contact with the bent portion 516A of the sealing member 510 positioned in the d1 direction. In the present disclosure, in a cross section including the central axis C and the center side tip Fpe of the small piece 514, the bent portion 516 positioned in the d1 direction with respect to the center CP is referred to as a bent portion 516A, and the bent portion 516 positioned in the d2 direction with respect to the center CP is referred to as a bent portion 516B.

When the ink inlet flow path member 710 moves further in the rear end side direction D2 in a state illustrated in FIG. 14, the ink inlet flow path member 710 comes into contact with the bent portion 516B of the sealing member 510 positioned in the d2 direction, and then comes into contact with the tip portion 526A of the valve body 520 as illustrated in FIG. 15. The bent portions 516A and 516B have a lower hardness than the small piece 514, and thus, when the ink inlet flow path member 710 comes into contact with the bent portions 516A and 516B, the bent portions 516A and 516B are bent due to an external force applied by the ink inlet flow path member 710. Therefore, even when the ink inlet flow path member 710 pushes the sealing member 510 at a position deviated from the center CP in the radial direction, the adjacent small pieces 514A and 514B are more easily displaced to follow the ink inlet flow path member 710 due to the bending of the bent portions 516A and 516B, and brought into close contact with the ink inlet flow path member 710 as compared to a sealing member that does not include the bent portion 516. As a result, it is possible to prevent ink leakage. Furthermore, as the small pieces 514 come into close contact with the ink inlet flow path member 710, it is possible to prevent air from entering the ink replenishment container 200, thereby reducing a possibility of over-injection of the ink.

Furthermore, when the ink inlet flow path member 710 is inserted into the sealing member 510 while being deviated from the center CP in the radial direction, the ink inlet flow path member 710 comes into contact with the bent portion 516 before the protruding portion 526 of the valve body 520 as described above. Therefore, even when there is a gap Gp between the valve body 520 and the small piece 514 through which the ink leaks, the small pieces 514A and 514B can come into close contact with the ink inlet flow path member 710 before the ink inlet flow path member 710 pushes the valve body 520 to open the spring valve 535. As a result, it is possible to prevent ink leakage. Furthermore, as the small pieces 514 come into close contact with the ink inlet flow path member 710, it is possible to prevent air from entering the ink replenishment container 200, thereby reducing a possibility of over-injection of the ink.

When the ink inlet flow path member 710 moves in the rear end side direction D2 in a state illustrated in FIG. 15, the valve body 520 transitions to the valve-opened state as illustrated in FIG. 16. In the ink replenishment container (not illustrated) in which the sealing member 510 does not include the bent portion 516 according to the related art, when the ink inlet flow path member 710 is inserted in a state in which the center of the ink inlet flow path member 710 is deviated from the center CP of the sealing member in the d1 direction on the left side, there may be variations in the way in which the slits Ap of the elastic portion positioned in the d1 direction are opened. Therefore, the elastic portion positioned in the d1 direction cannot follow the ink inlet flow path member 710, and there is a possibility of ink leakage. Furthermore, when there are variations in the way in which the slits Ap are opened, the slits Ap are not be able to maintain a capillary force, and the ink may leak. On the other hand, in the present embodiment, as the bent portion 516 is bent, the small piece 514 can be maintained in close contact with the ink inlet flow path member 710. Therefore, it is possible to prevent ink leakage.

In FIG. 16, the sealing member 510 is formed such that the length Lc along the outer surface of the elastic portion 512 in the cross section including the central axis C and the center side tip Fpe, which is the point of the small piece 514 closest to the center CP, is smaller than a length Le in the direction along the central axis from the connection portion Cn between the bent portion 516 and the inner circumferential wall 511 to the distal end of the ink inlet flow path member 710 in the valve-opened state. The length Lc along the outer surface of the elastic portion 512 is a length from the connection portion Cn to the center side tip Fpe of the small piece 514. The length Lc is a length of a thick line in FIG. 16. The length Lc is the same before and after the ink inlet flow path member 710 is inserted into the ink replenishment container 200. The above-described length relationship makes it possible to prevent the elastically deformed small piece 514 from impeding the flow of the ink and gas between the flow paths 711 and 712 of the ink inlet flow path member 710 and the inside of the container body 300 in the “valve-opened state” in which the ink inlet flow path member 710 pushes the valve body 520 and the valve body 520 is separated from the valve sealing portion Eg. Therefore, the ink replenishment is smoothly performed.

In FIG. 16, the sealing member 510 is formed such that the length Lc along the outer surface of the elastic portion 512 in the cross section including the central axis C and the center side tip Fpe, which is the point of the small piece 514 closest to the center CP, is smaller than a length Ld in the direction along the central axis C from the connection portion Cn between the bent portion 516 and the inner circumferential wall 511 to the valve sealing portion Eg. The length Ld is the same before and after the ink inlet flow path member 710 is inserted into the ink replenishment container 200. The above-described length relationship makes it possible to prevent the elastically deformed small piece 514 from impeding the flow of the ink and gas between the flow paths 711 and 712 of the ink inlet flow path member 710 and the inside of the container body 300 in the “valve-opened state” in which the ink inlet flow path member 710 pushes the valve body 520 and the valve body 520 is separated from the valve sealing portion Eg. Therefore, the ink replenishment is smoothly performed.

According to the first embodiment described above, the elastic portion 512 of the sealing member 510 has the bent portion 516. Therefore, even when the ink inlet flow path member 710 pushes the sealing member 510 at a position deviated from the center CP in the radial direction, the small pieces 514 easily follow the ink inlet flow path member 710 and come into close contact with the ink inlet flow path member 710 due to the bending of the bent portion 516. As a result, it is possible to prevent ink leakage. Furthermore, as the small pieces 514 come into close contact with the ink inlet flow path member 710, it is possible to prevent air from entering the ink replenishment container 200, thereby reducing a possibility of over-injection of the ink.

Further, the sealing member 510 is formed such that the thickness of the thinnest portion of the bent portion 516 in the direction along the central axis C is smaller than the thickness of the thinnest portion of the small piece 514, and the hardness of the bent portion 516 is lower than the hardness of the small piece 514. Therefore, the flexibility of the bent portion 516 is increased, which makes it easier for the small pieces 514 to follow the ink inlet flow path member 710. As a result, it is possible to prevent ink leakage. Further, as the small pieces 514 follow the ink inlet flow path member 710 and come into close contact with the ink inlet flow path member 710, the capillary force of the slits Ap prevents ink leakage. Furthermore, as the small pieces 514 come into close contact with the ink inlet flow path member 710, it is possible to prevent air from entering the ink replenishment container 200, thereby reducing a possibility of over-injection of the ink.

### B. Second Embodiment

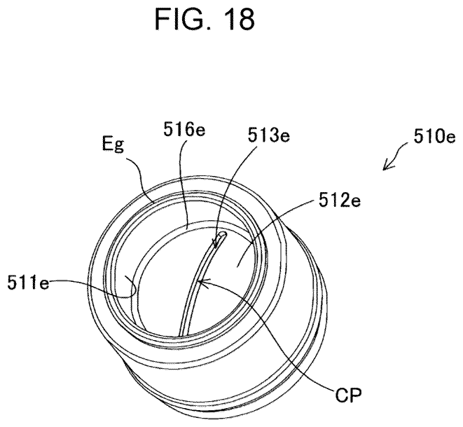

FIG. 17 is a cross-sectional view of a sealing member 510d in a second embodiment. In the second embodiment, a configuration of a bent portion 516d is different from that of the first embodiment. Other configurations are the same as those of the first embodiment. In the second embodiment, a thickness of the thinnest portion of the bent portion 516d in a direction along a central axis C is the same as a thickness of the thinnest portion of a small piece 514d in the direction along the central axis C. Meanwhile, the bent portion 516d is made of a material having a lower hardness than that of the small piece 514d. For example, the sealing member 510d except for the bent portion 516d can be made of an elastomer, and the bent portion 516d can be made by two-color molding of an elastomer and a low-hardness elastomer. For the low-hardness elastomer, for example, a micro network controlled structure (MNCS), which is a thermoplastic elastomer, can be used. The bent portion 516d may be made of a single material having a lower hardness than that of the sealing member 510d excluding the bent portion 516d. The hardness can be evaluated using, for example, Young's modulus as described above. The sealing member 510d of the second embodiment also has a structure in which the bent portion 516d is more flexible than the small piece 514d, so that the same effect as the first embodiment can be obtained.

### C. Other Embodiments

(C1) In the first embodiment described above, the bent portion 516 is bent in such a way as to protrude toward the ink outlet 460 in the direction along the central axis C, but the present disclosure is not limited thereto. Furthermore, when the ink inlet flow path member 710 is inserted into the ink outlet 460 while being deviated from the center CP in the radial direction, the ink inlet flow path member 710 comes into contact with both of the bent portions 516A and 516B, but the present disclosure is not limited thereto. The bent portion 516 does not have to protrude toward the ink outlet 460 in the direction along the central axis C. Furthermore, it is sufficient if the ink inlet flow path member 710 comes into contact with any one of the bent portions 516A and 516B when the ink inlet flow path member 710 is inserted into the ink outlet 460 while being deviated from the center CP in the radial direction, and the ink inlet flow path member 710 does not have to come into contact with both the bent portions 516A and 516B. That is, the length Lc along the outer surface of the elastic portion 512 may be smaller than that in the first embodiment. Also in the present embodiment, the bent portion 516 is bent at the time of replenishing the ink, so that the same effect as in the first embodiment can be obtained.

(C2) In the first embodiment described above, the thickness La of the thinnest portion of the bent portion 516 is smaller than the thickness Lb of the thinnest portion of the small piece 514, but the present disclosure is not limited thereto. The thickness La of the thinnest portion of the bent portion 516 does not have to be smaller than the thickness Lb of the thinnest portion of the small piece 514.

(C3) In the first and second embodiments described above, the small piece 514 of the sealing member 510 is not subjected to processing capable of enhancing the capillary force, but the present disclosure is not limited thereto. For example, the small piece 514 may be perforated, or the slit Ap of the small piece 514 may be processed to become uneven. The processing for enhancing the capillary force is not limited to the above-described perforation or unevenness processing, and other processing may be performed.

(C4) In the first and second embodiments described above, the sealing member 510 includes six small pieces 514 separated by six slits Ap, but the present disclosure is not limited thereto. Any number of multiple small pieces 514 separated by any number of multiple slits Ap may be provided. In addition, the sealing member 510 does not have to include the small pieces 514. FIG. 18 is a perspective view illustrating a sealing member 510e in Another Embodiment 1. The sealing member 510e has a tubular appearance, and has an inner circumferential wall 511e and an elastic portion 512e, similarly to the sealing member 510 of the first embodiment and the sealing member 510d of the second embodiment. The inner circumferential wall 511e has a cylindrical appearance centered on the central axis C of the ink outlet 460. The elastic portion 512e extends from the inner circumferential wall 511e toward the center CP, and has a bent portion 516e at a position where the elastic portion 512e is connected to the inner circumferential wall 511e. A single slit-shaped gap 513e including the center CP is formed in the elastic portion 512e. The gap 513e has a linear appearance in plan view. The gap 513e may have a curved appearance in plan view instead of the linear appearance. This gap 513e corresponds to the sealing member through-hole 510h of the first embodiment. Further, the elastic portion 512e corresponds to the elastic portion 512 in the sealing member 510 of the first embodiment and an elastic portion 512d in the sealing member 510d of the second embodiment.

(C5) In the first embodiment described above, a part of the distal end surface of the ink inlet flow path member 710 corresponds to the end portion of the partition wall 714 as illustrated in FIG. 10, and the partition wall 714 does not protrude in the axial direction from the ink inlet flow path member 710, but the present disclosure is not limited thereto. For example, the partition wall 714 may protrude in the axial direction from the ink inlet flow path member 710.

(C6) In the first embodiment described above, the ink inlet flow path member 710 has a cylindrical circumferential wall, and the end surface of the ink inlet flow path member 710 is flat, but the present disclosure is not limited thereto. The ink inlet flow path member 710 may have a cylindrical circumferential wall and have a step that is recessed in the axial direction at a distal end of the circumferential wall on an ink inlet side, and the sealing member 510 may be formed such that a width of the base of the small piece 514 is larger than a width of the step. In this case, the small piece 514 is hardly fitted into the step, which makes it difficult to impede the flow of liquid or gas. In addition, since it is easy to prevent some of the small pieces 514 from being fitted into the step, the plurality of small pieces 514 can be easily restored simultaneously, and it is easy to exert the effect of preventing ink leakage.

### D. OTHER ASPECTS

The present disclosure is not limited to the embodiments described above, and can be implemented in various configurations without departing from the scope of the present disclosure. For example, the technical features in the above embodiments corresponding to the technical features in each form described in the “Summary” section can be appropriately replaced or combined to solve some or all of the above-described problems or to achieve some or all of the above-described effects. Further, when the technical features are not described as essential in the present specification, the technical features can be deleted as appropriate.

(1) According to a first aspect of the present disclosure, an ink replenishment container is provided. The ink replenishment container that replenishes ink into an ink tank of a printer via an ink inlet flow path member that communicates with the ink tank includes: a container body configured to contain the ink; and an ink outlet forming portion connected to the container body and including a tube portion having an ink outlet, in which the ink outlet forming portion includes: a spring valve that includes a valve body mounted in the tube portion, and a spring biasing the valve body toward the ink outlet in a first direction along a central axis of the ink outlet in a valve-closed state, the spring valve configured to take a valve-opened state where the valve body is pushed by the ink inlet flow path member inserted into the tube portion in a second direction opposite to the first direction; and a sealing member that is mounted in the tube portion and has a valve sealing portion that is in contact with the valve body in the valve-closed state, the sealing member has a cylindrical inner circumferential wall centered on the central axis and an elastic portion extending from the inner circumferential wall toward a center of the sealing member, the elastic portion has slits that include the center and extend in a radial direction from the center toward the inner circumferential wall, a plurality of small pieces divided by the slits, and a bent portion positioned between the plurality of small pieces and the inner circumferential wall, and the spring valve is configured to take the valve-opened state where the elastic portion is pushed by the ink inlet flow path member to open the slits and the valve body is pushed by the ink inlet flow path member. According to this aspect, even when the ink inlet flow path member pushes the elastic portion of the sealing member at a position deviated from the center in the radial direction, the small pieces easily follow the ink inlet flow path member and come into close contact with the ink inlet flow path member due to the bending of the bent portion. As a result, it is possible to prevent ink leakage. Furthermore, as the small pieces come into close contact with the ink inlet flow path member, it is possible to prevent air from entering the ink replenishment container, thereby reducing a possibility of over-injection of the ink.

(2) According to the above aspect, the plurality of small pieces may form a through-hole at a position of the center, a tip portion of the valve body may be inserted into the through-hole when the spring valve is in the valve-closed state, and may be separated from the plurality of small pieces, and the bent portion of the elastic portion may be bent in such a way as to protrude toward the ink outlet in the first direction along the central axis. According to this aspect, when the ink inlet flow path member is inserted into the sealing member while being deviated from the center, the ink inlet flow path member comes into contact with the bent portion before the valve body. Therefore, even when there is a gap between the valve body and the small piece through which the ink leaks, the small pieces can come into close contact with the ink inlet flow path member before the ink inlet flow path member pushes the valve body to achieve the transition to the valve-opened state. As a result, it is possible to prevent ink leakage.

(3) According to the above aspect, the bent portion may have a lower hardness than that of the plurality of small pieces. According to this aspect, the flexibility of the bent portion is increased, which makes it easier for the small pieces to follow the ink inlet flow path member. As a result, it is possible to prevent ink leakage.

(4) According to the above aspect, a thickness of the thinnest portion of the bent portion in the direction along the central axis may be smaller than a thickness of the thinnest portions of the plurality of small pieces. According to this aspect, the flexibility of the bent portion is increased, which makes it easier for the small pieces to follow the ink inlet flow path member. As a result, it is possible to prevent ink leakage.

(5) According to the above aspect, the sealing member may be formed such that a length along an outer surface of the elastic portion in a cross section including the central axis and a center side tip, which is a point of the small piece closest to the center, is smaller than a length in the direction along the central axis from a connection portion between the bent portion and the inner circumferential wall to a distal end of the ink inlet flow path member in the valve-opened state. According to this aspect, it is possible to prevent the elastically deformed small piece from impeding the flow of the ink and gas between the flow paths of the ink inlet flow path member and the inside of the container body in the valve-opened state in which the ink inlet flow path member pushes the valve body and the valve body is separated from the valve sealing portion. Therefore, the ink replenishment is smoothly performed.

(6) According to the above aspect, the sealing member may be formed such that a length along an outer surface of the elastic portion in a cross section including the central axis and a center side tip, which is a point of the small piece closest to the center, is smaller than a length in the direction along the central axis from a connection portion between the bent portion and the inner circumferential wall to the valve sealing portion. According to this aspect, it is possible to prevent the elastically deformed small piece from impeding the flow of the ink and gas between the flow paths of the ink inlet flow path member and the inside of the container body in the valve-opened state in which the ink inlet flow path member pushes the valve body and the valve body is separated from the valve sealing portion. Therefore, the ink replenishment is smoothly performed.

The present disclosure can be implemented in various forms and can be implemented in forms such as a method for manufacturing an ink replenishment container, in addition to the above aspects.

What is claimed is:

1. An ink replenishment container that replenishes ink into an ink tank of a printer via an ink inlet flow path member that communicates with the ink tank, the ink replenishment container comprising:
a container body configured to contain the ink; and
an ink outlet forming portion connected to the container body and including a tube portion having an ink outlet,
wherein the ink outlet forming portion includes:
a spring valve that includes a valve body mounted in the tube portion, and a spring biasing the valve body toward the ink outlet in a first direction along a central axis of the ink outlet in a valve-closed state, the spring valve configured to take a valve-opened state where the valve body is pushed by the ink inlet flow path member inserted into the tube portion in a second direction opposite to the first direction; and
a sealing member that is mounted in the tube portion and has a valve sealing portion that is in contact with the valve body in the valve-closed state,
wherein
the sealing member has a cylindrical inner circumferential wall centered on the central axis and an elastic portion extending from the inner circumferential wall toward a center of the sealing member,
the elastic portion has slits that include the center and extend in a radial direction from the center toward the inner circumferential wall, a plurality of small pieces divided by the slits, and a bent portion positioned between the plurality of small pieces and the inner circumferential wall, and
the spring valve is configured to take the valve-opened state where the elastic portion is pushed by the ink inlet flow path member to open the slits and the valve body is pushed by the ink inlet flow path member.

2. The ink replenishment container according to claim 1, wherein the plurality of small pieces form a through-hole at a position of the center,
a tip portion of the valve body is inserted into the through-hole when the spring valve is in the valve-closed state, and is separated from the plurality of small pieces, and
the bent portion of the elastic portion is bent in such a way as to protrude toward the ink outlet in the first direction along the central axis.

3. The ink replenishment container according to claim 1, wherein the bent portion has a lower hardness than that of the plurality of small pieces.

4. The ink replenishment container according to claim 1, wherein a thickness of a thinnest portion of the bent portion in the direction along the central axis is smaller than a thickness of thinnest portions of the plurality of small pieces.

5. The ink replenishment container according to claim 1, wherein the sealing member is formed such that a length along an outer surface of the elastic portion in a cross section including the central axis and a center side tip, which is a point of the small piece closest to the center, is smaller than a length in the direction along the central axis from a connection portion between the bent portion and the inner circumferential wall to a distal end of the ink inlet flow path member in the valve-opened state.

6. The ink replenishment container according to claim 1, wherein the sealing member is formed such that a length along an outer surface of the elastic portion in a cross section including the central axis and a center side tip, which is a point of the small piece closest to the center, is smaller than a length in the direction along the central axis from a connection portion between the bent portion and the inner circumferential wall to the valve sealing portion.
